(19) United States
(12) Patent Application Publication
(10) Pub. No.: US 2010/0114923 A1
(43) Pub. Date: May 6, 2010

(54) Dynamic Font Metric Profiling

(75) Inventors: Michael J. McVady, Chicago, IL (US); Samuel Ying Cheung, Issaquah, WA (US); Nemanja Stefanovic, Elk Grove Village, IL (US); Lam Ping To, Barrington, IL (US); Olga Gerchikov, Buffalo Grove, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NOVARRA, INC.

(21) Appl. No.: 12/611,429

(22) Filed: Nov. 3, 2009

Related U.S. Application Data
(60) Provisional application No. 61/110,784, filed on Nov. 3, 2008.

(51) Int. Cl. G06F 15/16; G06F 17/00; G06F 17/30

(52) U.S. Cl. 707/758; 715/234; 707/802; 709/203; 707/E17.107; 707/E17.044

(57) ABSTRACT

A method and system for rendering web content is provided. According to one embodiment, when a user of a hand-held device makes a request to a server for web content, the server determines whether the request includes a metric data key. If the key is included, the server uses the key to retrieve a set of corresponding visual metric data from a database. The sever renders the requested content according to the retrieved visual metric data. If the key is not included in the request, then the server transmits to the device a request for visual metric data. The device responsively transmits back to the server the requested metric data, and the server renders the requested web content according to the received metric data. Additionally, the server may generate a unique key corresponding to the received metric data, transmit the key to the device for inclusion in future web content requests, and store the key and metric data in a database for later access.

### CROSS REFERENCE TO RELATED APPLICATION

The present patent application claims priority under 35 U.S.C. §119(e) to U.S. Provisional Patent Application Ser. No. 61/110,784, filed on Nov. 3, 2008, the entire contents of which are incorporated herein by reference as if fully set forth in this description.

### FIELD

The present application relates generally to the field of web browsing and network communications. More specifically, the application relates to a system and method for adapting and presenting information from web pages containing content designed for large screen computers to display on a hand-held device, such as a cellular telephone or personal digital assistance (PDA).

### BACKGROUND

Today, many worldwide web pages (HTML documents) are available that offer a variety of textual and non-textual content types. As known, a Web page is conventionally formatted via a standard page description language such as HyperText Markup Language (HTML), which typically contains text and can reference graphics, sound, animation, and video data. HTML provides for basic document formatting and allows a Web content provider to specify anchors or hypertext links to other Web servers and files. When a user selects a particular hypertext link, a Web browser reads and interprets an address, called a Uniform Resource Locator (URL) associated with the link, connects with a Web server at that address, and initiates an HTTP request for the file identified in the link. The Web server then sends the requested file to the Web browser to interpret and display the file to the user.

On a traditional desktop or laptop computer with a large screen running a standard web browser, HTML content types are easily arranged and displayed for viewing. For example, web sites for searching realtor property listings often deliver a plurality of images and text for the viewer to quickly scan for a property of interest. When the user identifies a property of interest, they can then read the details associated with the image of that specific property and select that image for further details about the property.

At the same time, the field of communications, and more specifically wireless telecommunications, is currently undergoing a radical expansion. This technological expansion allows an electronic device, such as mobile personal digital assistant (PDA), cellular phone, pager, and other electronic devices to connect to the same information sources, such as a web server or database, as one could with the PC and a PC-based browser. Several small device client browsers are available which deliver content from the web to the hand-held devices.

However, these small devices typically lack the screen space or navigation capabilities to display web content intended for display on a desktop or laptop computer. For example, hand-held devices may have displays that are small in size compared with desktop computer displays, and thus, portions of Web content, such as images and text that are otherwise displayable on a desktop computer display, may not be displayable on a hand-held computing device display unless some modifications are made to the images or text. Particularly, for example, a desktop computer display having an array of 1024 pixels by 1280 pixels may be able to easily display web content containing larger than normal font styles, and nontraditional Unicode characters, in the manner intended by the web content creator, due to the abundance of display space. In contrast, a hand-held computing device with a display having an array of 160 pixels by 120 pixels may not have the screen space to display the larger than normal font styles, or the nontraditional Unicode characters, in the manner intended by the web content creator. The characters of the text may be so wide, or so tall, that only a limited number of characters can appear on the screen at any one time. Accordingly, a user may need to scroll up or down on the display in order see all of the web content, resulting in a poor user experience.

A number of techniques are available for client or hand-held browsers to utilize to assist the user in navigating the web pages on the small screens. For example, client browsers may alter the layout of web content, change the positioning of images, or the size of textual characters.

### SUMMARY

Within embodiments described below, a method of providing rendered web content to a device is provided. The method includes a server receiving a request from a device for web content, and determining if the request includes a metric data lookup key. If the request does not include the metric data lookup key, then the method continues with the server transmitting a request for metric data to the device. After the server receives the requested metric data from the device, the server uses the metric data to render the web content in the best format for viewing on the device. Additionally, the method can include generating a specific metric data lookup key, based on the received metric data, and storing the received metric data with the lookup key in a database. The method may also include the server transmitting the metric data lookup key to the device so that the device can include the lookup key in any future requests for web content.

In another embodiment, a method for receiving rendered web content at a device is provided. The method includes a device transmitting a request for web content to a server. If the device has a metric data lookup key stored in memory, the device may include the lookup key with the web content request. If the device does not currently have a lookup key, or does not include a lookup key with the request, the device may subsequently receive a request for metric data. Responding to the request for metric data, the device may determine the appropriate metric data and send the metric data along to the server. The device may then receive the requested web content, rendered according to the provided metric data, as well as receive a metric data specific lookup key, for inclusion with future web content requests.

In another embodiment, a server is provided that comprises a processor and an interface coupled to the processor. The processor executes software applications stored in memory that include a server browser for receiving from an information source web content that includes text, retrieving a specific set of font metric data, and rendering the web content, according to the specific set of font metric data, into a format that is displayable on a mobile device. The interface may be operable to send the rendered web content over an air interface to a hand-held device.

These and other aspects will become apparent to those of ordinary skill in the art by reading the following detailed description, with reference where appropriate to the accompanying drawings. Further, it should be understood that the embodiments noted herein are not intended to limit the scope of the invention as claimed.

### BRIEF DESCRIPTION OF FIGURES

FIG. 1 is a block diagram illustrating an example system for accessing, adapting, and presenting web content to electronic devices.

FIG. 2 is an example of several definitions of font metrics.

FIG. 3 illustrates an example flow diagram that illustrates a sequence of actions performed within the system of FIG. 1.

FIG. 4 is a flowchart depicting example functional steps for a method of profiling a requesting device and rendering requested web content for the requesting device.

FIG. 5 is a block diagram illustrating one example of a server for performing the method depicted in the flowchart of FIG. 4.

FIG. 6 illustrates one example of a system such as that shown in FIG. 1 with multiple servers.

### DETAILED DESCRIPTION

The present application provides a manner of converting information content (web content) for display on hand-held or mobile devices. Some information content includes text originally formatted for display on larger, desktop displays, which, when viewed on certain hand-held devices, appears too large. Hand-held devices may include functionality to convert (or render) the information content into a format able to be viewed on the hand-held device. However, in an effort to reduce program file sizes, and processing power on the part of hand-held device, example embodiments below enable rendering functionality to occur on the server to provide the web content to the hand-held device. Servers that provide web content to hand-held devices can be connected to fixed electrical supplies and have more processing power than hand-held devices. Thus, battery life is not of the same concern with respect to web content servers as it is with respect to hand-held devices.

When shifting web content rendering functionality to the server side, the server may not know the best method to render the web content for each individual device. Currently, there exists a wide range of differing hand-held devices, each with their own visual metric data (i.e., screen sizes, browser viewing areas, character sets, etc.). In order to best display the web content, each device may demand a different rendering process. For example, one particular device may be well-suited for displaying large text, and so a rendering process may format textual characters of a requested website to be rather large. Another particular device requesting the same website may not be well-suited for displaying large text. Such a device may have smaller screen dimensions, or a lower screen resolution. If the same rendering process is used for both devices, text display on the latter device may appear in an undesirable manner, such as on top of images, or spanning multiple lines. One way for a server to appropriately render web content for each of the wide range of devices, is to maintain a database of every possible requesting device along with that device's visual metric data requirements. The visual metric data requirements may need to be manually collected from each of the hand-held devices (a process called profiling), stored in the database, and updated as needed. However, it may be difficult to keep such a database up-to-date, due to the massive number of new devices coming into the market each year. Further, maintaining a database of each individual hand-held device along with corresponding visual metric data may not be sufficient, as identical devices may have differing visual metric data due to selectively applied firmware upgrades, individually installed applications, add-ons, modifications, etc. Therefore, example methods herein enable automatic collection of visual metric data from a hand-held device, as well as methods for a hand-held device to request a given rendering based on that hand-held device's specific visual metric data requirements, thereby providing the rendered web content to each individual hand-held device.

Within embodiments described below, a server may accordingly render requested information content for display on the hand-held devices. In order to determine the proper rendering metrics for each device, the server dynamically profiles each device as the server makes an initial web content request, generates a unique key based on the metric data, and stores the metric data and key in a database. The unique key is transmitted back to the requesting device for inclusion in future requests for web content. In this manner, the database is dynamically populated with unique sets of metric data as devices transmit web content requests. Each set of metric data is tied to a unique key so that when devices include the key in subsequent content requests, the server responsively uses the key to retrieve a set of metric data from the database in order to render requested web content in a preferred manner. A database maintained in this manner is efficient, since each database entry is tied to a unique set of metric data as opposed to being tied to a specific device.

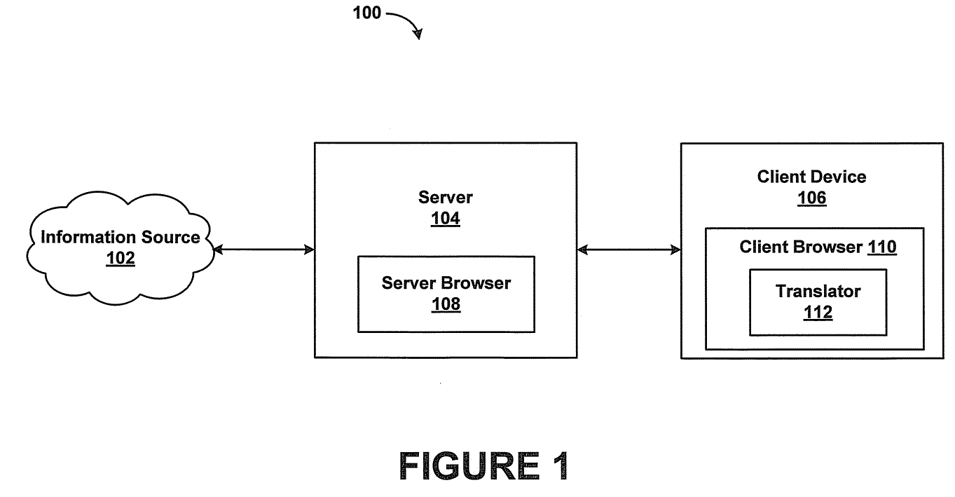

Referring now to FIG. 1, a high-level diagram is shown illustrating an exemplary system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 provides information content expressed in a markup language, such as, for example, those markup languages known in the art including Hypertext Markup Language (HTML), Extensible Markup Language (XML) with or without Extensible Style Sheets (XSL), VoiceXML, Extensible Hypertext Markup Language (XHTML), or Wireless Markup Language (WML). Furthermore, the information content can reference images, video, or audio information to be provided by the information source 102.

The information source 102 can be accessed through any type of network by the server 104 via a server browser 108. The server browser 108 may communicate with the client device over any type of network through a client browser 110. The server browser 108 acts as a proxy between the client browser 110 and the information source 102 of web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102. By utilizing HTTP requests, such as is known in the art, the server browser 108 can access information content, including applications, static and dynamic content, at the information source 102.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. However, it should be understood that the server browser 108 and client browser 110 can be hosted on the same platform such as on an electronic device, if the platform or electronic device has the appropriate hardware and network capabilities. Thus, within many embodiments herein, functionality may be described as being part of the client browser 110 or as being part of the server browser 108. It should be understood that the client device 106 and the server 104 may co-exist on the same device, and thus functionality of either can be substituted by each other. Thus, the client browser 110 may perform functions explained as being performed by the server browser 108, and the server browser 108 may perform functions explained as being performed by the client browser 110. By utilizing the server and client browser, smaller electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the server 104 and the client device 106 generally execute application programs resident at the server 104 and the client device 106 under the control of an operating system. The application programs, such as the server browser 108 and the client browser 110, may be stored on memory within the server 104 and the client device 106 and may be provided using machine language instructions or software with object-oriented instructions, such as the Java programming language. However, other programming languages (such as the C++ programming language for instance) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as W3C (www.w3.org) Voice Extensible Markup Language (VoiceXML). One skilled in the art of computer systems will understand that the example embodiments are not limited to any particular class or model of computer employed for the client device 106 and will be able to select an appropriate system.

To provide an exemplary illustration, assume that a PDA hosts a client browser 110, a PC hosts the server browser 108, and the PDA and PC are both connected to an Ethernet network. Then, the client browser 110 and the server browser 108 could perform information transactions over the Ethernet network. Such transactions would utilize Ethernet or similarly IEEE 802.3 protocols. Nevertheless, in this example, the client and server browsers communicate over a wired network. The communications might also include a wireless network such as a local area wireless network (LAWN) or wireless local area network (WLAN). Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 112 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g. HTML form submission) are preserved.

Information content from the information source 102 is retrieved and can be tailored for use on the client browser 110 by the server browser 108. Alternatively, the server browser 108 may retrieve the information and send the information to the client browser 110, which itself tailors the information appropriately for viewing. Content transformations may be necessary since the requested content (e.g., a web page) could have been initially designed for viewing on a large screen of a PC, rather than on a limited screen size of a hand-held device. As a result, either the server browser 108 or the client browser 110 can perform information content rendering transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, QDOM, script executor, normalizer, and serializer, for example. Additional information pertaining to information content transformation or customization is included in U.S. Pat. No. 7,072,984, entitled “System and method for accessing customized information over the internet using a browser for a plurality of electronic devices,” U.S. patent application Ser. No. 10/280,263, entitled “System and Method for Displaying Information Content with Selective Horizontal Scrolling,” U.S. Pat. No. 7,500,188, entitled “System and Method for Adapting Information Content for an Electronic Device,” U.S. patent application Ser. No. 11/526,992, entitled “System and Method for Web Navigation Using Images,” and U.S. patent application Ser. No. 11/869,239, entitled “Method and System for Converting Interactive Animated Information Content for Display on Mobile Devices,” the contents of each of which are incorporated herein by reference as if fully set forth in this description.

The system 100 includes software (within the client device 106 or the server 104) for modifying web content into a format for display on the client device 106. As used herein, web content may refer to a web page received from information source 102, or a file downloaded from information source 102. Web content, as an example, may include blocks of text, pictures, or video files. Modifying web content having one characteristic to form web content having a different characteristic is referred to as web content rendering, and more generally as just rendering. Example characteristics of web content can include (but are not limited to) font metrics, image sizes, video bit rates, etc.

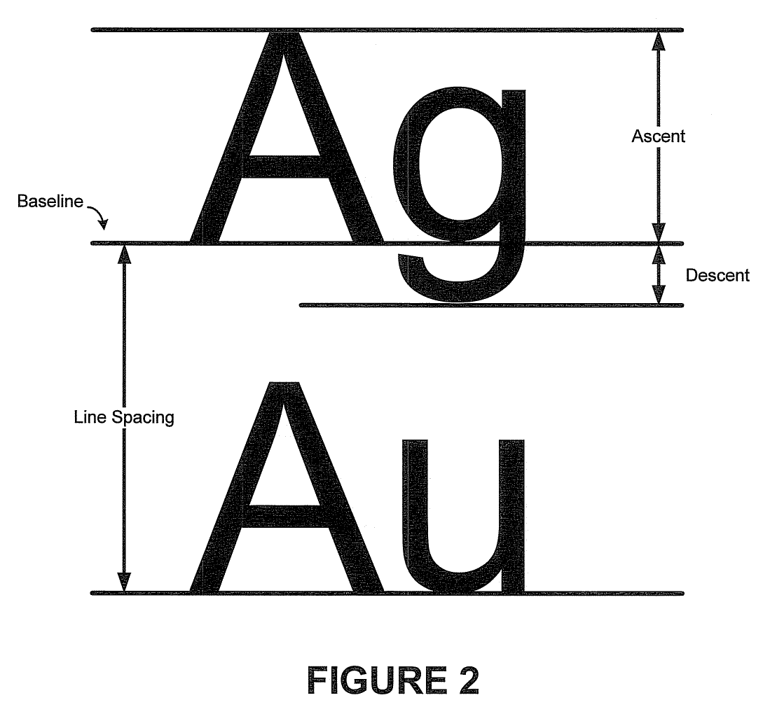

Each web content characteristic may demand a different rendering process. A font rendering process, for example, re-formats characters of text according to a set of predetermined font metric data. FIG. 2 illustrates example font metrics, which could be included in a set of visual metric data, including “ascent”, “descent”, and “line spacing”. Font metrics are usually measured in pixels (although other units can be used as well, such as millimeters, or microns), and measured with reference to a “baseline”. The baseline is defined as the bottom of most characters. Certain characters have portions that appear below the baseline, such as a letter ‘g’. Descent can be defined as the distance from the baseline to the bottom of any portion appearing below the baseline. Ascent can be defined as the height of a character. And line spacing can be defined as the distance between baselines of consecutive lines. Font metric data may also include other definitions not shown in FIG. 2, such as character width, or line thickness.

A hand-held device that receives content from server 104 may have many possible font styles that the device can display. For example, a device may be able to display two fonts, Times New Roman and Arial, and each may be able to be displayed in one of four styles, Plain, Bold, Italic, and Bold-Italic. Each font and style may further be able to be displayed in one of three font sizes, 0, 1, and 2. For each of these possibilities, the device may maintain a maximum amount of pixels for the characters of a specific font. For example, the device may prefer that the ascent of characters displayed in Plain Times New Roman size 0 to be no more than 10 pixels. The device may compile all the preferred maxima into a file, or table, forming a unique set of font metric data. Such an example table is illustrated, in a truncated form, below in Table 1. One skilled in the art should recognize that characters could be displayed in more or less fonts, different styles, and in more or fewer possible sizes. Although not shown, the file or table may also include additional metrics such as character width. The file or table may specify a preferred character width, in pixels, for each Unicode character (or a subset of commonly used Unicode characters).

TABLE 1

| Font Size | Font Name | Font Style | Metric | Max Pixels |
|---|---|---|---|---|
| 0 | Times New Roman | Plain | Ascent | 10 |
| 0 | Times New Roman | Plain | Descent | 2 |
| 0 | Times New Roman | Bold | Ascent | 12 |
| 0 | Times New Roman | Bold | Descent | 4 |
| 1 | Arial | Plain | Ascent | 9 |
| 1 | Arial | Plain | Descent | 5 |
| 1 | Arial | Bold | Ascent | 11 |
| 1 | Arial | Bold | Descent | 6 |
| . . . | . . . | . . . | . . . | . . . |

Since server 104 renders web content for such a wide range of devices, the server 104 may refer to a database when rendering web content for a particular device. As noted above, however, manually profiling each device and storing the corresponding visual metric data in a database has become quite difficult, due to the sheer number of devices, as well as the possibility of identical devices having different preferred visual metric data (caused by firmware upgrades, and differing browser software). Various embodiments of the present application are provided herein that enable the server 104 to dynamically profile each device 106 as the device requests web content, as well as provide to each device 106 web content specifically rendered based on each device's preferred metrics.

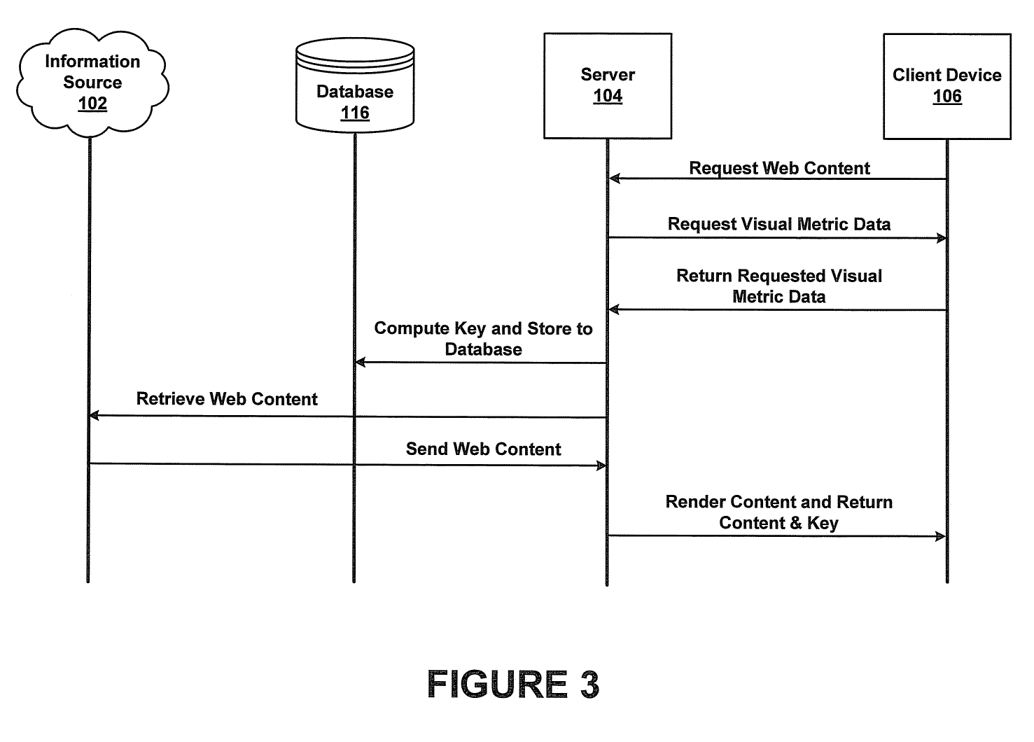

FIG. 3 illustrates an example flow diagram that illustrates a sequence of actions performed within the system of FIG. 1 according to an embodiment of the present application. Initially, as shown, the client device 106 will make a request for web content. If the request for web content is the first such request device 106 has made of server 104, then server 104 will send a request for visual metric data to the client device 106. Visual metric data may include preferred font metric maxima, preferred image sizes and resolutions, video bit rate preferences, physical dimensions of screen viewing areas, and any combinations thereof specific to the type and model of the client device. Upon receiving a request for visual metric data, the client device may retrieve from memory such visual metric data and return the data to server 104. The server 104 receives the visual metric data, generates a unique key based on the visual metric data, and stores the key and the metric data to a database 116. Alternatively, the key generating functionality may take place at the client device. In this manner, a device may generate a unique metric data key beforehand, and during a first request for web content, the client device would send the metric data and the unique key to the server for storage in a database. Each subsequent request for web content may just include the key so as to enable the server to retrieve the appropriate metric data pertaining to the key (and thus the requesting device).

The unique key may be generated in a number of ways. One way, for example, is to feed the metric data into a hash function. Many known hash functions exist, such as message digest algorithm 5 (MD5), secure hash algorithm 512 (SHA512), Skein, and Tiger, for example, and serve to convert a large amount of data into a unique, smaller datum, such as an integer—called a hash. Hash functions are example key generators since it is unlikely that two different hash function inputs (visual metric data, in this case) will result in an identical hash. This allows the server 104 to uniquely identify a specific set of visual metric data given a specific key. Using this approach, the number of database entries is minimized since each entry is confined to a unique set of metric data. The database may contain exactly the number of entries needed to support every requesting device. One skilled in the art should recognize that other key generating functions exist and can be used in place of hash functions, such as cyclic redundancy checks (CRCs) and Checksums, or that variations may be made to the hash functions stated above.

The flow diagram continues as the server 104 then retrieves the web content from the information source 102 and renders the content based on the provided visual metric data. The server 104 then sends the rendered web content and the key to the client device 106. The client device 106 may automatically store the key in memory and include the key in any future requests for web content.

The preceding flow describes an embodiment in which a device 106 makes a first request for web content from the server 104, however, on subsequent requests for web content from server 104, the flow may be modified. For example, if the device includes the key with a future request, the server 104 will recognize the receipt of the key and responsively forgo the requesting of the visual metric data. The sever 104 will then retrieve from the database 116 the visual metric data pertaining to the key and render the requested web content based on the retrieved metric data. This expedites the process since the device 106 does not have to send the entire set of preferred visual metric data with each request.

The server 104, client device 106, or both, may be connected to one or more short message service centers (SMSC), which may send any of the aforementioned requests (or other messages, including the return of data) in the form of an SMS message. An SMSC may function as a store-and-forward system for messages. The system 100 provides the mechanisms required to find a destination client device, such that an SMSC may then transport messages to the destination client device. The SMSC may forward the SMS message to the client device using an SMS delivery point-to-point (SMSDPP) format (e.g., accomplished via the use of “forwardShortMessage” mechanisms as defined in IS-41). However, if the client device is inaccessible at any time during which the SMSC is attempting to deliver a message, the SMSC may then store the message until a later time when the MS becomes accessible. Several mechanisms are available to send notification messages to the client devices through an SMSC. For example, paging networks, specialized software for personnel computer based messaging, and operator bureaus can initiate a notification message.

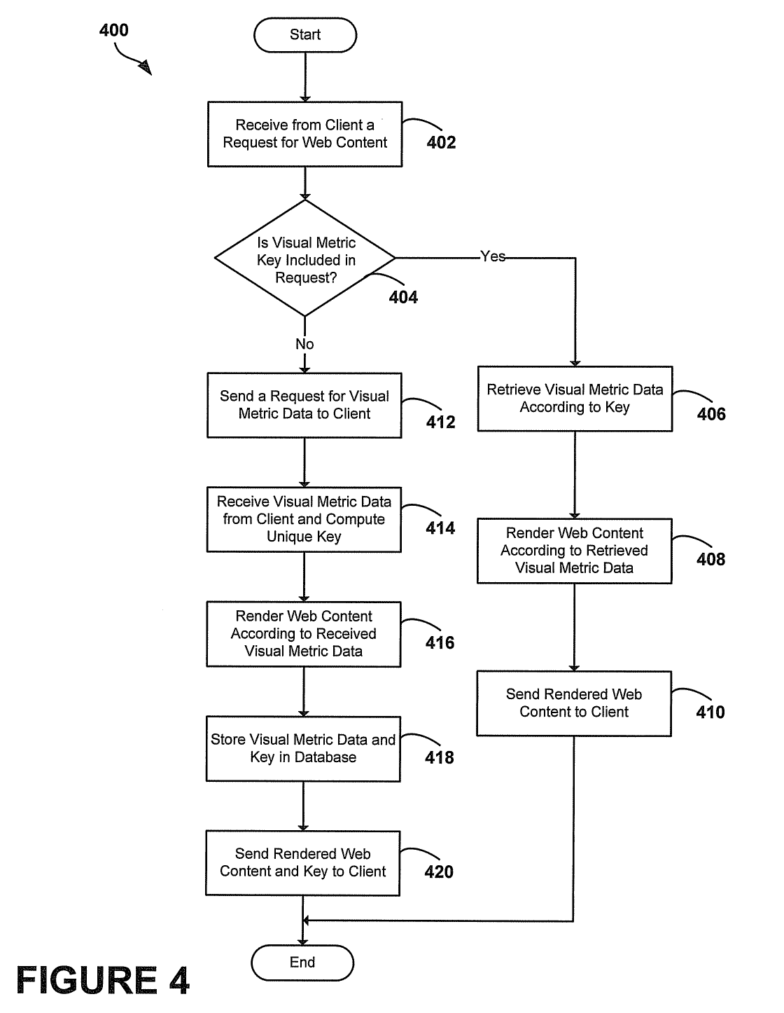

FIG. 4 is a flowchart depicting functional steps for a method 400 of rendering web content for display on a client device. It should be understood that each block (or arrow) in this flowchart (and within other flow diagrams presented herein) may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

First, the server browser will receive a request for web content from the client browser, as shown at block 402. The web content may be a typical web page (e.g., HTML document), or one or more files, including text and images associated therewith.

After receiving the request, the server will make a determination, as shown in block 404, of whether the request included a visual metric key, such as the unique key discussed above. If the determination is that the request included the unique key, the method continues at block 406 where the server uses the key to lookup the appropriate metric data. At block 408, the server retrieves the requested content from information source 102 and renders the content according to the retrieved metric data. At block 410, the server sends the rendered web content to the client device.

Referring back to block 404, if the determination is that the request did not include a visual metric key, then the method continues with block 412 where the server sends a request for visual metric data to the client device. The device responsively returns the requested visual metric data to the server, as shown in block 414. Here, the server computes a unique key based on the received visual metric data. The server may compute the key, for example, by running the metric data through a hash function.

The sever then retrieves the requested content from information source 102 and renders the content according to the received metric data, as shown in block 416. The method continues at block 418 where the server stores the visual metric data with the unique key in a database for later access. Finally, the server sends the rendered web content to the device along with the unique key, for inclusion in subsequent requests for web content, as shown in block 420.

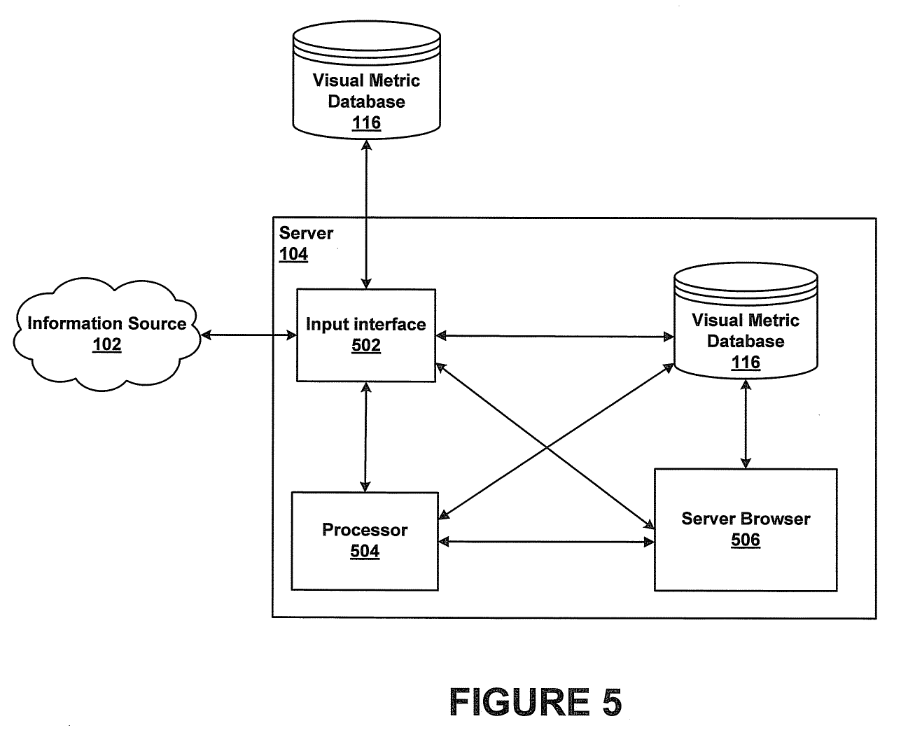

FIG. 5 is a block diagram illustrating one example of a server 104 for performing the method depicted in the flowchart of FIG. 4. The server 104 includes an input interface 502 coupled to a processor 504 and a server browser 108. The server browser 506 may be stored in memory (not shown) so that the processor 504 accesses the memory to execute software or program instructions that enable operation of the server browser 506. The server browser 506 may include components such as a TCP/IP engine (not shown). The server browser 506 is a software application that is executable by the processor 504 to read an electronic document or electronic data, and render the data into a visual display of text and/or graphics for display, based on certain rendering inputs (such as visual metric data). The server browser 506 may include such operating functional components as windows, pull-down menus, buttons, and scroll bars, and thus may be a typical web browser. Serve 104 may also include one or more databases 116 for housing visual metric data received by a requesting device.

The server 104 will receive requests for information from client devices, and will responsively access the information source 102 to retrieve the information. The server 104 will then be operated by the processor 504 to convert the information into a form accessible by the requesting client device. For example, a client device may request a typical web page, and thus the server 504 will access the Internet and retrieve the requested web page. The processor may then access database 116 to retrieve an appropriate set of visual metric data, such as a set of font metrics pertaining to the client device, in order to properly render the requested web page for the requesting device. The processor may execute code to render the text on the webpage to conform to the retrieved set of font metrics, and thereafter send the rendered web page to the requesting device.

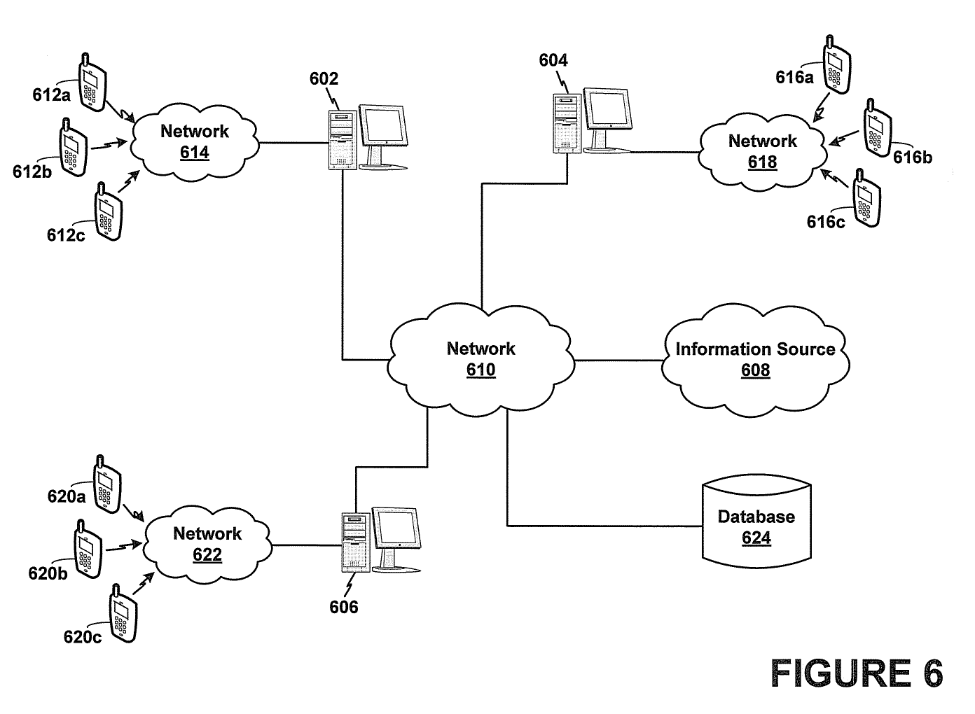

The methods above have been described with reference to a single server and client device system. However, the system may include many servers each of which communicates with many client devices at any given time. FIG. 6 illustrates one embodiment of a system with multiple servers, for example. The system includes servers 602, 604 and 606 each of which is connected to an information source 608 via a network 610. Many client devices communicate with each server individually. For example, client devices 612a-c communicate with server 602 through network 614, client devices 616a-c communicate with server 604 through network 618 and client devices 620a-c communicate with server 606 through network 622.

The networks 614, 618 and 622 may be wireless networks, such as a CDMA network, or wired networks like an Ethernet network. Further, although networks 614, 618 and 622 are shown to be separate networks, the networks 614, 618 and 622 may be the same network or a subset of the same network, so that all client devices 612a-c, 616a-c and 620a-c and servers 602, 604 and 606 communicate over the same network. In this regard, network 610 may be a wired or wireless network and may also be the same network as the networks 614, 618 and 622. Thus, each server and client device cluster may communicate over the same network, for example.

Methods of the present application can be used within the system of FIG. 6 to optimize resources, and lessen wait times for client devices to receive requested web content. With the centralized database 624 present in the system, many techniques may be implemented to optimize processing power of the servers. For example, servers 602, 604, and 606 may all access database 624 in order to retrieve or store visual metric data. Therefore, if a device roams from network to network, whichever server is currently hosting the device will still be able to retrieve the appropriate visual metric data from the centralized database 624, as opposed to re-requesting the metric data from the device.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

In view of the wide variety of embodiments to which the principles of the present application can be applied, it should be understood that the illustrated embodiments are exemplary only, and should not be taken as limiting the scope of the present application. For example, the steps of the flow diagrams may be taken in sequences other than those described, and more or fewer elements may be used in the block diagrams. While various elements of embodiments have been described as being implemented in software, in other embodiments in hardware or firmware implementations may alternatively be used, and vice-versa.

Note that while the present application has been described in the context of a fully functional server and client device system and method, those skilled in the art will appreciate that mechanisms of the present application are capable of being distributed in the form of a computer-readable medium of instructions in a variety of forms, and that the present application applies equally regardless of the particular type of signal bearing media used to actually carry out the distribution. For example, a computer usable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals. As such, the methods described herein may be embodied in a computer program product that includes one or more computer readable media, as described as being present within the server 104 or the client device 106.

The claims should not be read as limited to the described order or elements unless stated to that effect. Therefore, all embodiments that come within the scope and spirit of the following claims and equivalents thereto are claimed as the invention.

What is claimed is:

1. A method of providing rendered web content to a device, the method comprising:
receiving from the device a request for web content;
making a determination of whether the request includes a metric data lookup key;
when the request does not include the metric data lookup key, transmitting to the device a request for metric data;
receiving from the device specific metric data pertaining to display characteristics of the device;
using the received specific metric data to render the requested web content; and
transmitting to the device over an air interface the rendered web content.

2. The method of claim 1, wherein the request for web content includes the metric data lookup key.

3. The method of claim 1, further comprising: receiving from the device the metric data lookup key in a message separate from the request for web content.

4. The method of claim 1, further comprising:
when the request includes a metric data lookup key, using the metric data lookup key to retrieve metric data pertaining to the device from a database.

5. The method of claim 1, further comprising:
generating, based on the specific metric data, a particular metric data lookup key, the particular metric data lookup key being unique for any metric data that matches the specific metric data; and
transmitting to the device the unique metric data lookup key.

6. The method of claim 5, wherein generating, based on the specific metric data, a particular metric data lookup key comprises:
computing a hash function using the specific metric data as an input to the hash function, wherein the particular metric data lookup key is an output of the hash function.

7. The method of claim 5, further comprising:
storing the specific metric data and the particular metric data lookup key to a database, wherein the specific metric data is distinctively keyed to the particular metric data lookup key.

8. The method of claim 7, further comprising:
receiving from a second device a second request for a second web content, wherein the second device is different from the first device, and wherein the second request includes the particular metric data lookup key;
using the specific metric data lookup key to retrieve from the database the specific metric data;
using the specific metric data to render the requested second web content; and
transmitting to the second device over an air interface the rendered second web content.

9. The method of claim 5, further comprising:
a server receiving from the device a request for web content and the specific metric data; and
the server generating the particular metric data lookup key.

10. The method of claim 1, wherein the metric data is font metric data including a maximum pixel preferences pertaining to sizes of text to be displayed on the device for each type and style of font to be displayed on the device.

11. The method of claim 10, wherein using the font metric data to render the requested web content comprises replacing text used in the requested web content with text that conforms to the font metric data.

12. The method of claim 11, wherein font metric data comprises maximum pixel preferences for one or more font metrics pertaining to textual characters of a particular font, size, and style, wherein the font metrics are selected from the group consisting of ascent, descent, line spacing, and character width.

13. The method of claim 1, wherein the device is a mobile hand-held device.

14. A method of receiving rendered web content at a device, the method comprising:
transmitting to a server over an air interface a request for web content;
receiving from the server a request for metric data;
transmitting to the server over the air interface metric data pertaining to the device;
receiving from the server the requested web content, wherein the web content is rendered according to the determined metric data; and
receiving from the server a metric data lookup key, the metric data lookup key uniquely corresponding to the metric data.

15. The method of claim 14, further comprising:
transmitting to the server over an air interface a second request for a second web content, the second request including the metric data lookup key; and
receiving from the server the requested second web content, wherein the second web content is rendered according to the determined metric data.

16. The method of claim 14, further comprising storing the metric data lookup key in the device.

17. The method of claim 14, wherein the metric data is font metric data.

18. The method of claim 14, wherein the device is a mobile hand-held device.

19. A server comprising:
a processor for executing software applications stored in memory, the software applications including a server browser for (i) receiving web content from an information source, wherein the web content includes text, (ii) retrieving from among a plurality of font metric data sets a specific font metric data set pertaining to a mobile device, and for (ii) rendering the text included in the web content according to the specific font metric data set to form rendered web content; and
an interface coupled to the processor for sending the rendered web content over an air interface to the mobile device.

20. The server of claim 19, further comprising a database for maintaining the plurality of font metric data sets.
